(19) United States
(12) Patent Application Publication
(10) Pub. No.: US 2008/0056210 A1
(43) Pub. Date: Mar. 6, 2008

(54) Moving Networks Information Server

(75) Inventor: Raziq Yaqub, Stewartsville, NJ (US)

Correspondence Address: WATCHSTONE P+D, PLC, 1250 CONNECTICUT AVENUE, N.W., SUITE 700, WASHINGTON, DC, 20036-2657, US

(73) Assignees: TOSHIBA AMERICA RESEARCH, INC., Piscataway, NJ (US); TELCORDIA TECHNOLOGIES, INC., Piscataway, NJ (US)

(21) Appl. No.: 11/694,984

(22) Filed: Mar. 31, 2007

Related U.S. Application Data
(60) Provisional application No. 60/804,823, filed on Jun. 14, 2006.

(51) Int. Cl. H04Q 7/24

(52) U.S. Cl. 370/338

(57) ABSTRACT

A system and method for assisting and guiding mobile devices to connect to available networks along a route of a vehicle, comprising; having a mobile information server on a vehicle collect network information from networks along the route of the vehicle and transmit said network information to a plurality of mobile devices carried by the vehicle.

The present application claims priority under 35 U.S.C. 119 to provisional application No. 60/804,823 filed on Jun. 14, 2006 entitled Dual Functionality Moving Networks Information Server to R. Yaqub.

### BACKGROUND

1. Field of the Invention

The present application relates to wireless communications and in particular to, inter alia, methods and systems for facilitating roaming across heterogeneous access technologies.

2. General Background Discussion

Networks and Internet Protocol:

There are many types of computer networks, with the Internet having the most notoriety. The Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

With respect to IP (Internet Protocol), this is a protocol by which data can be sent from one device (e.g., a phone, a PDA [Personal Digital Assistant], a computer, etc.) to another device on a network. There are a variety of versions of IP today, including, e.g., IPv4, IPv6, etc. Each host device on the network has at least one IP address that is its own unique identifier. IP is a connectionless protocol. The connection between end points during a communication is not continuous. When a user sends or receives data or messages, the data or messages are divided into components known as packets. Every packet is treated as an independent unit of data.

In order to standardize the transmission between points over the Internet or the like networks, an OSI (Open Systems Interconnection) model was established. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below.

Wireless Networks:

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components; a transceiver (i.e., a transmitter and a receiver, including, e.g., a single chip transceiver with an integrated transmitter, receiver and, if desired, other functions); an antenna; a processor; one or more audio transducers (for example, a speaker or a microphone as in devices for audio communications); electromagnetic data storage (such as, e.g., ROM, RAM, digital data storage, etc., such as in devices where data processing is provided); memory; flash memory; a full chip set or integrated circuit; interfaces (such as, e.g., USB, CODEC, UART, PCM, etc.); and/or the like.

Wireless LANs (WLANs) in which a mobile user can connect to a local area network (LAN) through a wireless connection may be employed for wireless communications. Wireless communications can include, e.g., communications that propagate via electromagnetic waves, such as light, infrared, radio, microwave. There are a variety of WLAN standards that currently exist, such as, e.g., Bluetooth, IEEE 802.11, and HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together. Bluetooth devices may be named according to a common naming concept. For example, a Bluetooth device may possess a Bluetooth Device Name (BDN) or a name associated with a unique Bluetooth Device Address (BDA). Bluetooth devices may also participate in an Internet Protocol (IP) network. If a Bluetooth device functions on an IP network, it may be provided with an IP address and an IP (network) name. Thus, a Bluetooth Device configured to participate on an IP network may contain, e.g., a BDN, a BDA, an IP address and an IP name. The term “IP name” refers to a name corresponding to an IP address of an interface.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a PCMCIA card or another device; a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, Multiple interface Devices (MIDs), 802.11x devices (IEEE 802.11 devices including, e.g., 802.11a, 802.11b and 802.11g devices), HomeRF (Home Radio Frequency) devices, Wi-Fi (Wireless Fidelity) devices, GPRS (General Packet Radio Service) devices, 3G cellular devices, 2.5G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, e.g., Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds means to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using, e.g., Internet Control Message Protocol (ICMP).

In basic IP routing (e.g., outside mobile IP), routing mechanisms rely on the assumptions that each network node always has a constant attachment point to, e.g., the Internet and that each node's IP address identifies the network link it is attached to. In this document, the terminology “node” includes a connection point, which can include, e.g., a redistribution point or an end point for data transmissions, and which can recognize, process and/or forward communications to other nodes. For example, Internet routers can look at, e.g., an IP address prefix or the like identifying a device's network. Then, at a network level, routers can look at, e.g., a set of bits identifying a particular subnet. Then, at a subnet level, routers can look at, e.g., a set of bits identifying a particular device. With typical mobile IP communications, if a user disconnects a mobile device from, e.g., the Internet and tries to reconnect it at a new subnet, then the device has to be reconfigured with a new IP address, a proper netmask and a default router. Otherwise, routing protocols would not be able to deliver the packets properly.

Illustrative Computer Architectures:

FIG. 4 shows illustrative computer or the like structure that can be used to implement computerized process steps, to be carried out by devices, such as, e.g., a server and/or a mobile device. In some embodiments, a server, computer, node or control unit includes a central processing unit (CPU) 322, which can communicate with a set of input/output (I/O) device(s) 324 over a bus 326. The I/O devices 324 can include, for example, a keypad, monitor, and/or other devices. The CPU 322 can communicate with a computer readable medium (e.g., conventional volatile or non-volatile data storage devices) 328 (hereafter “memory 328”) over the bus 326. The interaction between a CPU 322, I/O devices 324, a bus 326, and a memory 328 can be like that known in the art. Memory 328 can include, e.g., data 330. The memory 328 can also store software 338. The software 338 can include a number of modules 340 for implementing the steps of processes. Conventional programming techniques may be used to implement these modules. Memory 328 can also store the above and/or other data file(s). In some embodiments, the various methods described herein may be implemented via a computer program product for use with a computer system. This implementation may, for example, include a series of computer instructions fixed on a computer readable medium (e.g., a diskette, a CD-ROM, ROM or the like) or transmittable to a computer system via and interface device, such as a modem or the like. A communication medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices, in the various embodiments, the transmission may use any appropriate communications technology.

### REFERENCES

The present invention provides a variety of advances and improvements over, among other things, the systems and methods described in the following references, the entire disclosures of which references are incorporated herein by reference: I.E.T.F, internet draft, of networking mobility working group of the I.E.T.F. entitled Network Mobility Route Optimization Problem Statement, draft-ietf-nemo-ro-problem-statement-02.txt, Dated Dec. 28, 2005 (Hereinafter, “Reference [1]”).

### SUMMARY

The present invention improves upon the above and/or other background technologies and/or problems therein.

According to some embodiments, a mobile information server system is provided that includes a mobile information server configured to be supported on a vehicle carrying a plurality of passengers and a plurality of mobile devices; said mobile information server being configured to collect network information from networks along a route of the vehicle and configured to transmit said network information to the plurality of mobile devices carried by the vehicle. According to some embodiments, the mobile information server is further configured to transmit said network information to a fixed information server that transmits said network information to mobile devices that are not in communication with said mobile information server. According to some embodiments, said mobile information server is configured to transmit said network information to said fixed information server via a power line. According to some examples, said mobile information server is configured to transmit said network information to said fixed information server via a wireless interface. According to some examples, said mobile information server assists and guides the plurality of mobile devices carried by the vehicle to connect with available networks along a route of the vehicle without providing routing functions. According to some embodiments, said mobile information server is a multiple interface device configured to provide information to mobile devices via a plurality of interfaces. According to some embodiments, said mobile information server is configured to inform said fixed information server to take an appropriate action to handle a gang handover due to the mobility of plural mobile devices in said vehicle.

According to some other embodiments of the invention, a mobile information server system includes: a vehicle for carrying a plurality of passengers and a plurality of mobile devices; a mobile information server supported by said vehicle; said mobile information server being configured to collect network information from networks along a route of the vehicle and configured to transmit said network information to a plurality of mobile devices carried by the vehicle; a plurality of mobile devices carried by the vehicle; said mobile devices being configured to receive broadcasts from said mobile information server to obtain information about network elements along a route of the vehicle. In some examples, said broadcasts include IP packets that are addressed to mobile devices of subscribed customers.

According to yet some other embodiments of the invention, a method for assisting and guiding mobile devices to connect to available networks along a route of a vehicle, comprising: having a mobile information server on a vehicle collect network information from networks along the route of the vehicle and transmit said network information to a plurality of mobile devices carried by the vehicle. In some embodiments, the method further includes having said mobile information server transmit said network information to a fixed information server that transmits said network information to mobile devices that are not in communication with said mobile information server.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is an architectural diagram showing an illustrative concept of dual functionality moving “networks information server;”

FIG. 2 is a flow diagram showing an illustrative method for how an MIS can be populated in some embodiments;

FIG. 3 is a flow diagram showing an illustrative method for how a database can be maintained in some embodiments; and

FIG. 4 is an architectural diagram showing illustrative computer or the like structure that can be used to implement computerized process steps, to be carried out by devices, such as, e.g., a server and/or a mobile device.

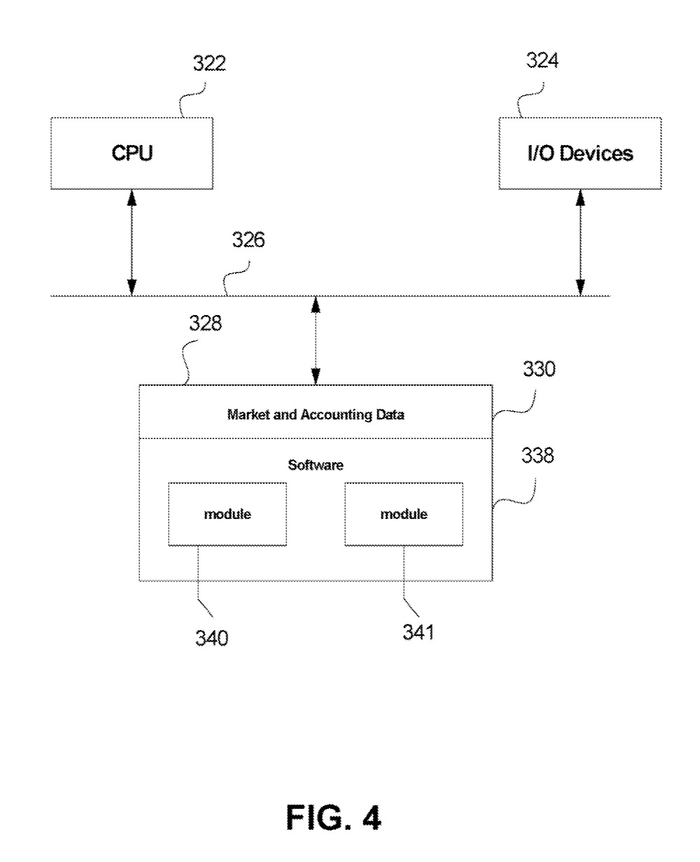

### DISCUSSION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

Overview

Future Mobile Communication Systems will focus on integration of heterogeneous Radio Access Technologies. These technologies may comprise, e.g., PANs (Personal Area Networks with very small coverage), WLANs (Local Area Networks with comparatively large coverage area), and WANs (Wide Area Networks with comparatively larger coverage area e.g., cellular or WiMAX). Since focus is on integration, the requirements are more stringent than those for simply interworking. One such requirement is global roaming across these heterogeneous Radio Access Technologies with ubiquitous and transparent service provisioning. Global Roaming necessitates efficient method for quick vertical handovers, which in turn demands an efficient way of Heterogeneous Radio Access Networks Discovery. Several techniques have been proposed, however they have some drawbacks. We propose a new approach in this application that comprises a Moving Information Server (MIS). Such an Information Server can be installed, e.g., in vehicles, such as, e.g., trains, trams, buses, or any mass public transport system, etc., and can serve two purposes:

1: Acts as a Moving Information Server (MIS). In this regard, it can provide information ahead of time to, e.g., the Mobile Nodes (MNs) sitting in the vehicle (such as, e.g., passengers carrying an MN on a train, in a bus or the like) about the available networks in the geographical domain the vehicle is passing through or about to pass through. The Moving Networks Information Server (MIS) maintains the updated list of the Known Networks mapped with the location information. The MIS collects network information by receiving radio signals from the networks and or by actually connecting to the networks that fall on the track/route of the vehicle, and the Location Information through, e.g., a GPS Receiver. It is assumed that MIS in public vehicles can keep the updated information about the networks because it will pass through the same networks on the route it goes over periodically (e.g., several times a day). The MNs can receive network information from MIS through broadcasts, query-response, or combination of both. Preferably, the MIS is Multiple interface Device capable of delivering information on Multiple Radio Interface (e.g., IEEE 802.11, 802.16, 3GPP or 3GPP2). Preferably, the MN can pick the information through an interface it is currently using.

2: Act as a Reporting Agent. In it sends the copy of the same information (i.e. about the available networks mapped with GPS coordinates) to a Fixed Information Server (FIS) located somewhere in the Network. The FIS can serve those MNs which are not traveling in public vehicles and, thus, do not have access to MIS (e.g., pedestrians or travelers in private vehicles lacking a MIS). The communication channel between the MIS and the FIS may be either any appropriate Wireless Link or a Broadband Power Line (BPL).

Because the MIS installed in the vehicles is preferably capable of performing the above noted two functions at a time, we refer it to as Dual Functionality Moving Networks Information Server.

Introduction

Seamless integration of heterogeneous wireless networks is a major step towards a new generation of wireless networks. This seamless integration requires capabilities to support seamless handover to enable service continuity across heterogeneous Radio Access Technologies (RATs). The following are certain key capabilities to support seamless handover across heterogeneous RATs:
Quick network discovery: To discover the existence of networks and information regarding the networks that a mobile station (MN or mobile for simplicity) will need to handover to.
Down selection of candidate networks: When multiple networks are available at the same time, a MN needs to quickly select one network to use.
Proactive handover: A MN may perform proactive handover actions before it actually hands over into a target network to reduce handover delay. For example, the MN may pre-acquire a local IP addresses from, and pre-authentication with, a target network.

The Known methods of “Networks Discovery” focus on two-stage approach.

Stage—1: Populating Information Server: Establishing an Information Server somewhere in the network, and filling it with the Networks Information by means of Reporting Agents (RAs). The RAs are regular MNs that collect the information about Network Elements in a domain they happen to visit and send it to the Information Server (e.g., if a specific network element is attached/detached or becomes operational/non-operational its information is reported to the Information Server by RA).

Stage—2: Reuse of Information Server's Information: Reuse of Information Server's information by new mobile entrants in that domain—i.e., any MN when it enters in a new domain can inquire to the Information Server about the Network Elements in that domain and get information in advance about Network Elements of any domain.

Drawbacks in the Background

There are drawbacks in both above noted stages. In Stage—1 (i.e., Populating Information Server) each and every MN that happens to enter in a domain, unaware of the fact that the previously present or passing-by MNs have already updated the Information Server, keeps on sending/replicating the same information about the domain it is passing through. This not only unnecessarily keeps the Information Server busy in processing the replicated information but also generates signaling burdens on the network gratuitously. Furthermore, since Reporting Agents are regular subscribers, they may not be trusted RAs.

In Stage—2 (Reuse of Information Server's Information), the prior methods assume that the MN is aware of Information server's reachable location. This method may not work well or may be inefficient if the MN is not aware of the Information Server's reachable locations, thus, bringing-in an unnecessary time delay.

Our proposed solution, in addition to the above noted issues (that are mainly related to the construction of database and its use), can also solve the problems posed by “Simultaneous Gang Handovers”—i.e., when a large number of MNs (e.g., in the train) move together, a large number of simultaneous handovers can occur. If the radio access network could get the knowledge ahead of time about this joint gang handover, it can better manage its available resources.

Furthermore, our proposed solution can also resolve the problems faced by “Moving Networks.” See Reference [1]. A Moving Network is a network which changes, as a unit, its point of attachment to the Network. To reduce the latency for promoting efficient session continuity for moving networks, the NEMO working group in IETF is proposing Mobile Routers. However, route optimization is a major concern. Several solutions have been proposed, among which establishing bi-directional tunnels seems the promising one. However, they have drawbacks of their own nature. For example, in the case of establishing a bidirectional tunnel, all communications to and from nodes in a mobile network must go through the bi-directional tunnel established between the Mobile Router and its Home Agent when the mobile network is away. Although such an arrangement allows Mobile Network Nodes to reach and be reached by any node on the Internet, the limitations associated to the base protocol degrade overall performance as it adds new delays (because of increased packet size, increased chance of packet fragmentation, and increased susceptibility to link failure, etc.) that eventually introduce bottleneck traffic congestion. The problem is further compounded by nesting of Mobile Networks that can ultimately stalemate all communications to and from the Mobile Network Nodes in specific dispositions. Our proposed idea of an MIS can be an alternative to Mobile Routers to achieve the objective. Where MIS does not provide the routing, but assists and guides MN to connect to the available networks that happen to fall on its way, in a quick, efficient and timely manner.

### The Approach of the Preferred Embodiments

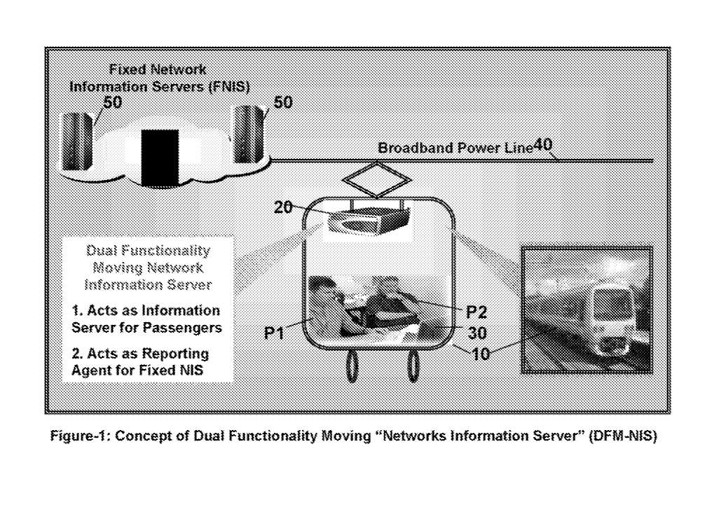

This application describes a new method, which not only can overcome the above captioned flaws and other flaws of the prior art but also provides a number of advantages, such as, e.g., listed below. According to some embodiments of present approach, as portrayed in FIG. 1, the Dual Functionality Moving Networks-Information-Server plays the roles of an MIS and a Reporting Agent and, preferably, has following functionalities.

With reference to FIG. 1, the figure depicts an illustrative embodiment of a dual functionality moving “networks information server” (DFM-NIS). As shown in FIG. 1, a vehicle 10 (e.g., a train as shown), includes a Moving Network Information Server (MIS) 20. As illustrated in FIG. 1, the vehicle 10 preferably has a plurality of passengers therein, such as, e.g., passengers P1 and P2 shown in the illustrative example. Moreover, the passengers preferably have a plurality of mobile devices or mobile nodes (MN) 30 (e.g., a personal computer, laptop computer and/or the like). In this illustrative embodiment, the train is powered via a broadband power line 40 (e.g., electrical power line). Moreover, in this illustrative embodiment the train communicates with a plurality of fixed Network Information Servers 50 (two shown in the illustrative embodiment). As also shown, the MIS can communicate in some embodiments with a FNIS via a wireless transmission system. As shown in FIG. 1, the MIS preferably operates as a dual functionality Moving Network Information Server in which it 1) acts as an Information Server for passengers and 2) acts as a reporting agent for a fixed Network Information Server (NIS).

1. Functionalities of Moving Information Server as MIS and Reporting Agent:

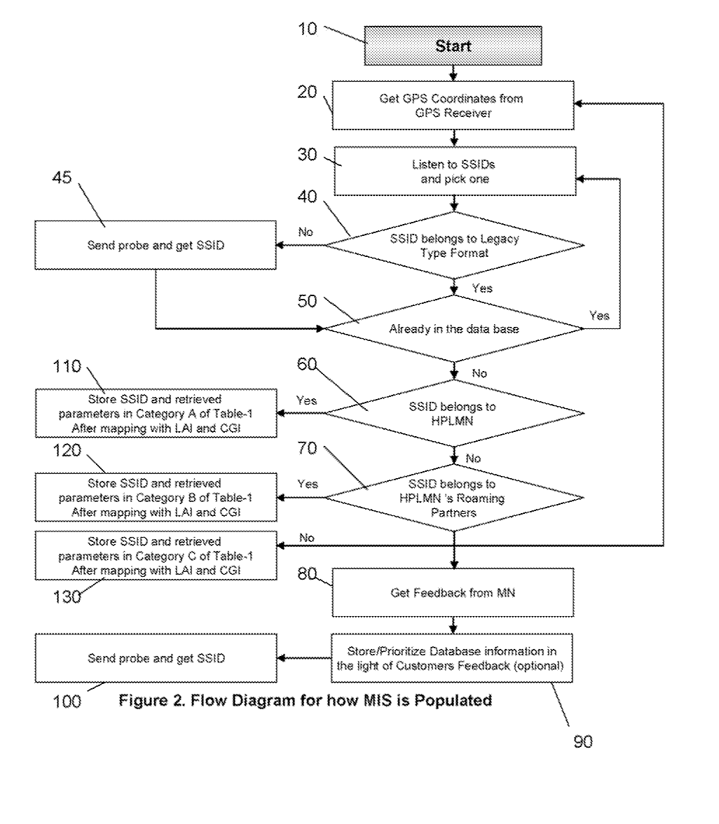

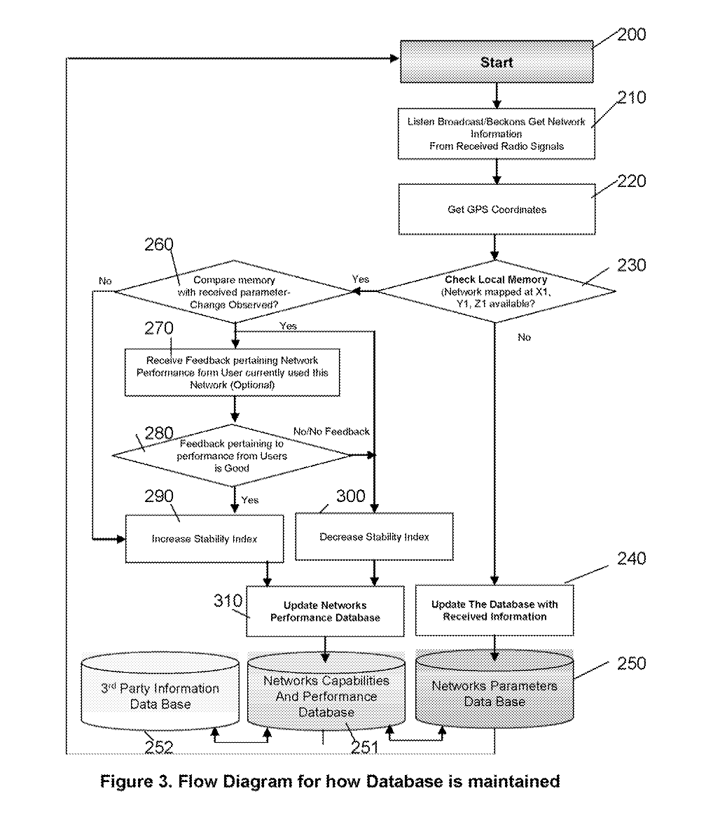

In the preferred embodiments, the MIS is made capable of performing at least some and preferably all of the following functions:
1. MIS is Capable of: Listening to the information received through Broadcasts and or Beckons from Cellular Networks (3GPP, 3GPP2, etc.) and from Non-Cellular networks (e.g., WLANs, WiMAX, PANs, etc.). The MIS collects this information by receiving radio signals from the networks and/or by actually connecting to the networks that fall on the track/route of the vehicle. In some preferred embodiments, this can be done as per the algorithm shown in FIG. 2. It is assumed that an MIS in, e.g., a public vehicle can keep the updated information about the networks because it will, e.g., traverse the same or similar route periodically (e.g., several times a day).
With reference to FIG. 2, the figure shows an illustrative flow diagram depicting process steps for how an MIS database can be populated according to some illustrative embodiments. In this regard, in the illustrative example, at a first step 10, the process is started. Next, at step 20, the system receives GPS coordinates from a GPS receiver. Next, at step 30, the system listens to SSIDs and picks one. Next, at step 40, the system evaluates if an SSID belongs to a Legacy Type Format. If the answer at step 40 is no, the system proceeds to step 45 and sends a probe and gets the SSID and then proceeds to step 50. If the answer is yes at step 40, the system proceeds to step 50. At step 50, the system evaluates if it is already in the database. If the answer is yes at step 50, the system process back to step 30. If the answer is no at step 50, the system proceeds to step 60. At step 60, the system evaluates if the SSID belongs to HPLMN. If the answer is yes at step 60, the system proceeds to step 110 and stores the SSID and retrieved parameters in Category A of a Table-1, after mapping with LAI and CGI. If the answer is no at step 60, the system proceeds to step 70 and evaluates if the SSID belongs to HPLMN's Roaming Partners. If the answer is yes at step 70, the system goes to step 120 and stores the SSID and retrieved parameters in Category B of a Table-1, after mapping with LAI and CGI. If the answer is no at step 70, the system proceeds to step 80 and gets feedback from the mobile node (MN), and goes to step 90 optionally and stores/prioritizes the database information in the light of Customer's Feedback, and goes to step 100 and sends a probe and gets an SSID. Also, if the answer is no, the system goes to step 130 and stores the SSID and retrieved parameters in Category C of Table-1, after mapping with LAI and CGI and goes to step 20 and gets GPS coordinates from GPS receiver.
2. MIS is Capable of: Comparing the information (between the messages received recently and already stored information) and comprehending the inconsistencies as per, e.g., the algorithm shown in FIG. 3.
3. MIS is Capable of: Storing the Updated Information in its database. The MIS maintains the updated list of the Known Networks mapped with the location Information. MIS will be capable of Storing Information about Network Element Categorically duly Mapped with Geographical Location Coordinates and Time. In the preferred embodiments, there are three categories of stored information: “Primary Information;” Secondary Information; and 3^{rd} Party Information. Primary Information can include, for example, SSIDs of available networks, addresses of a DHCP server, an address of an authentication server, etc. Secondary Information can include network capabilities and can be considered as the additional information that can include higher layer information or detailed information about lower layers. For example, Type of Security Protocols supported (e.g., Open Access Control; Universal Access Control; or 802.1X Access Control), Type of Internet Protocols supported (e.g., IPv4, IPv6, etc.). Support for Quality of Service (QoS), Support for interworking with other networks, Existence of Roaming Relationship and Names of Roaming Partners, Pricing Information, and Services Supported by the networks. These two categories of information will help the MN to determine the candidate networks and perform pre-authentication with the best one ahead of time. The 3^{rd} Party Information can be, e.g., location based Information provided to the interested MNs that otherwise the MN has to acquire from a Location Server, located at the far end of the network, at the expense of extra signaling and battery consumption. The significance of categorizing the information in Primary, Secondary and 3^{rd} Party is that some of the Information may be Broadcasted (e.g., Primary Information can be broadcasted) and some of the information can be acquired on query response basis (e.g. Secondary Information, or 3^{rd} Party Information can be fetched based on need). Preferably, the database is maintained as per, e.g., the algorithm shown in FIG. 3.
With references to FIG. 3, FIG. 3 shows an illustrative flow diagram for how a database is preferably maintained according to some illustrative embodiments. In this illustrative example, the database includes three databases—i.e., a 3^{rd} party information database 320, a networks capabilities and performance database 330 and a networks parameters database 250. As shown, at step 200, the system is started. Next, at step 210, the system listens to broadcasts/beckons and gets network information from received radio signals. Next, at step 220, the system gets GPS coordinates. Next, at step 230, the system checks local memory (e.g., is the network mapped at X1, Y1, Z1 available?). If the answer is no at step 230, the system goes to step 240 and updates the database with received information. If the answer is yes at step 230, the system goes to step 260 and evaluates to compare memory with the received parameter-change observed. If the answer is no at step 260, the system proceeds to step 290 and increases a stability index and next proceeds to step 310 and updates the Networks Performance Database. If the answer is yes at step 260, the system proceeds to step 300. Also, if the answer is yes at step 260, the system proceeds to optional step 270 and receives feedback pertaining to Network Performance from Users currently using this network. Next, at step 280, the system evaluates if the feedback pertaining to performance from the Users is good. If the answer is at step 280 is no/no feedback, the system goes to step 300 and decreases the stability index and next proceeds to step 310 and updates the Networks Performance Database. If the answer at step 280 is yes, the system proceeds to step 290 and increases the stability index, and next proceeds to step 310 and updates the Networks Performance Database.
4. MIS is Capable of: Providing information to the Mobile Nodes sifting in the vehicles, ahead of time, about the available networks in the geographical domain the vehicle is passing through or about to pass through.
5. MIS is Capable of: Delivering MNs the network information through broadcast, or query-response, or combination of both. The MIS is a Multiple Interface Device and is capable of providing information to the MN through, e.g., a radio interface the MN is currently using (e.g., IEEE 802.11, 802.16, 3GPP or 3GPP2).
6. MIS is Capable of: Pushing or notifying the information to the FIS, thus updating the FIS database accordingly, in this manner, it also acts as a reporting agent for the FIS.
7. MIS is capable of: Sending ONLY Updated Information to the FIS either on Broadband Power Line (BPL) or any appropriate Wireless Interface (in case BPL for backhaul connection is not available). In this regard, the BPL is used to deliver IP-based broadband services on electric power lines. The FCC is trying to create competition with, e.g., copper telephone lines and cable television coaxial cable lines.
8. MIS is capable of: Informing the FIS to take an appropriate action to handle simultaneous gang handovers that may result due to the mobility of several MNs in a moving vehicle with active calls. FIS in turn may inform the appropriate base station to manage its radio resources accordingly.

2. Functionalities of the Fixed Information Server:

The MIS and the FIS are both Information Servers. One difference is that the MIS is a Moving Information Server, and the FIS is a Fixed Information Server. Moreover, the FIS has comparatively less functionalities. In some embodiments, the FIS is capable of performing at least some and preferably all of the following tasks:
1. FIS will be capable of Receiving ONLY Updated Information about Network Elements of domains through different MIS.
2. FIS will be capable of Storing Information (e.g., a duplicate copy of Information that MIS has provided to it).
3. FIS will also be capable of delivering Primary, Secondary, or 3^{rd} Party Information to the MNs, through MN inquiries only.
4. FIS, on default, is a recipient of duplicate copy of Information that the MIS provides to it. However, it has a special feature under which it can supply and/or overwrite the information contained in MIS. This information can be, e.g., operator's policy driven or 3^{rd} party information. Thus, for example, advertisements, etc., can come from the FIS to the MIS for further delivery to the MNs.
5. FIS is capable of informing appropriate Base station/Access Point to manage radio resources to handle a simultaneous gang handover that may result due to the mobility of an entire Network with active calls.

3. Functionalities of MNs:

According to some embodiments of this approach, the Mobile Nodes are made capable of performing at least some, preferably all, of the following functions:
1. The MNs are capable of listening to the Broadcasts from the MIS to get Primary Information about Network Elements. In another embodiment of the present invention, for charging purposes (e.g., fees), the broadcasts can be IP packets that are addressed to those MNs who are subscribed customers.
2. The MNs are capable of obtaining Secondary or Additional Information about Network Elements by sending a direct query to the MIS. The partition between the Primary and Secondary Information is policy/implementation based. Both the Primary and Secondary Information received through Broadcasts from and through query to the MIS, respectively, will help the MN to, e.g., determine the available candidate networks, down select the best candidate as per its own policy and preferences, and perform pre-authentication with the best one ahead of time. In the preferred embodiments, the 3^{rd} Party Information is not used for Network Discovery, but to provide supplementary services.

Once the MN has selected the best network, it can initiate essential steps to perform proactive secured handoff (e.g., sending PANA authentication message to the PANA server, renewal of IP address with DHCP server of the candidate network, and sending a binding update to the correspondent host (CH) or to the home agent).

4. Merits of the Proposed Solution

This approach will not only surmount the flaws present in the existing techniques but also provides a number of potential advantages, including, e.g.;
1. It can solve discovery database construction problems because, e.g., it constructs a database in an automated, dynamic and efficient way. Furthermore, network discovery and updated reports, being constructed in the MIS and reported by the MIS to the FIS will be trusted—i.e., in contrast to when regular MNs are acting as reporting agents.
2. Since the MIS is made capable of sending only the updated information, this can eliminate the redundant signaling traffic as well as relieve the FIS from unnecessary processing of replicated information. In contrast, in existing techniques all Reporting Agents whenever and wherever they find any network just keep on sending the information to the Networks Data Server, which increases signaling traffic on the Network and processing burdens on the FIS.
3. The MIS can provide the MNs with quick and reliable information about the neighborhood networks. It can do this because; (a) the MIS can keep updated information about the networks—for example, when used in a vehicle, such as, e.g., a public vehicle (e.g., a public transportation vehicle in some illustrative embodiments), it will traverse the same route periodically (e.g., several times a day); and (b) the MIS is local and relatively stationary with respect to the MN.
4. The superfluous signaling traffic on the network will be reduced. This can be achieved because every MN will be able to get the desired information about heterogeneous networks from the Local MIS.
5. Regardless which interface of a MN is active, the MN will be able to retrieve the desired information from the MIS because the MIS is a multiple air interface Server capable of sending information on several heterogeneous air interfaces.
6. The proposed approach will be able to reduce the battery consumption for the MN. This can be achieved because, e.g., it can fetch the desired information locally, and using an air interface that is already active.
7. Since the MIS can also provide location based information, this can relinquish the MNs from keeping their own global position systems (GPS) ON, thus offering power saving to the MNs. Furthermore, if can also reduce location based data and signaling traffic on the network. This is desirable for both users and network service providers.
8. The MIS can also store and deliver 3^{rd} parties information to the MNs. This will create a Business case for e.g., advertisers and network operators. In addition, it can make a business case for railway companies, or mass transport companies, as they can assist network operators to provide guaranteed service to the users even if the users utilize heterogeneous networks. It can also make business case for 3^{rd} parties who might be interested in providing location based advertisements or information services.
9. The MIS can inform the radio access network ahead of time about a simultaneous gang handover, thus enabling it to manage its available resources in a timely manner. This is a very desirable benefit/feature for, e.g., network operators.
10. It can be an alternative solution to the Mobile Routers concept. The concept of Mobile Router for Moving Networks is being pursued by the NEMO working group of the IETF with an objective to reduce latency. In our proposed idea, the MIS does not provide the routing to the moving network, but assists and guides the MNs of a moving network to connect the available networks on their way in quick, efficient and timely manner, thus reducing the latency and delays, which is also the key objective of NEMO. Notably, in the context of Moving Networks, Mobile Routers and Gateways to the outer world have to be automatically discovered and re-established after departure/failure of a gateway; however, the MIS can also serve as a discoverer of Mobile Routers and Gateways in advance to assure continuous reachability.

### BROAD SCOPE OF THE INVENTION

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

1. A joint protection system, comprising:
a garment made of cloth having a closed pocket over a joint location; and
an elastomeric pad encased in the closed pocket.

2. The system of claim 1, wherein the garment is pants and the joint location is a knee.

3. The system of claim 2, wherein the closed pocket is sewn into a seam of the pants.

4. The system of claim 3, wherein the closed pocket has no visible seams.

5. The system of claim 2, wherein the elastomeric pad has a non-rectangular shape.

6. The system of claim 5, wherein the elastomeric pad had a plurality of sub-pads.

7. The system of claim 6, wherein one of the plurality of sub-pads is a side pad.

8. A knee protection system, comprising:
a pair of pants having a closed pocket covering a knee location; and
a butterfly shaped pad encased in the closed pocket.

9. The system of claim 8, wherein the butterfly shaped pad is made of an elastomeric material.

10. The system of claim 9, wherein the butterfly shaped pad has a pair of side pads.

11. The system of claim 10, wherein the butterfly shaped pad has a non-rectangular patella pad.

12. The system of claim 11, wherein the butterfly shaped pad has a top pad.

13. The system of claim 8, wherein the closed pocket is sewn into a seam of the pants.

14. The system of claim 13, wherein the closed pocket has no visible seams.

15. A knee protection system, comprising:
a pair of pants; and
an integrated pad in the pair of pants covering a knee location, wherein the integrated pad is not removable from the pair of pants and the integrated pad is made of a material that does not absorb water.

16. The system of claim 15, further including a plurality of integrated pads.

17. The system of claim 16, wherein each of the plurality of integrated pads are encased in a closed pocket in the pair of pants.

18. The system of claim 15, wherein the integrated pad is made of an elastomeric material.

19. The system of claim 17, wherein the closed pocket is sewn into a seam of the pants.

20. The system of claim 19, wherein the closed pocket has no visible seams.
